(19) United States
(12) Patent Application Publication
(10) Pub. No.: US 2014/0278866 A1
(43) Pub. Date: Sep. 18, 2014

(54) SYSTEMS, METHODS AND APPARATUS FOR COMPENSATING A MEMBER OF AN ONLINE SOCIAL NETWORK FOR RECRUITMENT OF NEW MEMBERS

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC., Las Vegas (US)

(21) Appl. No.: 14/209,801

(22) Filed: Mar. 13, 2014

Related U.S. Application Data
(60) Provisional application No. 61/792,750, filed on Mar. 15, 2013.

(51) Int. Cl. G06Q 30/02; G06Q 50/00

(52) U.S. Cl. CPC G06Q 30/0214; G06Q 50/01
USPC 705/14.16

(57) ABSTRACT

A website accessible via a network to a first plurality of registered users is maintained, wherein the first plurality of registered users comprises a second plurality of paying members and a third plurality of non-paying members. Registration information indicating that a person has registered, status information indicating whether the person has registered as a paying member or a non-paying member, and referring member identification information identifying a particular one of the first plurality of users as a member who referred the person, is received. Referring member status information indicating whether the particular one of the first plurality of users is a paying member or a non-paying member is examined. A sum is paid to the particular one of the first plurality of user based on the status information and the referring member status information.

This application claims priority from U.S. Provisional Application No. 61/792,750, filed Mar. 15, 2013, which is hereby incorporated by reference herein in its entirety.

### TECHNICAL FIELD

This specification relates generally to systems and methods for managing an online social network, and more particularly to systems and methods for compensating a member of an online social network for recruitment of new members.

### BACKGROUND

Growth of the Internet has facilitated use of online social networks. Social networks have become popular online environments in which users may interact in various ways, purchase goods and services, meet new friends, maintain online blogs, etc. Recruitment of new members to a social network typically occurs by virtue of the social network's popularity, through advertising, by through word-of-mouth, etc.

### SUMMARY

In accordance with an embodiment, a method is provided. A website accessible via a network to a first plurality of registered users is maintained, wherein the first plurality of registered users comprises a second plurality of paying members and a third plurality of non-paying members. Registration information indicating that a person has registered, status information indicating whether or not the person has registered as a paying member or a non-paying member, and referring member identification information identifying a particular one of the first plurality of users as a user who referred the person, is received. Referring member status information indicating whether or not the particular one of the first plurality of users is a paying member or a non-paying member is examined. A sum is paid to the particular one of the first plurality of users based on the status information and the referring member status information.

In another embodiment, the sum comprises a first amount if the particular one of the first plurality of users is a paying member and the person has registered as a paying member, a second amount if the particular one of the first plurality of users is a paying member and the person has registered as a non-paying member, a third amount if the particular one of the first plurality of users is a non-paying member and the person has registered as a paying member, and a fourth amount if the particular one of the first plurality of users is a non-paying member and the person has registered as a non-paying member.

In another embodiment, second registration information indicating that a second person has registered, second status information indicating whether or not the second person has registered as a paying member or a non-paying member, and second referring member identification information identifying the person as a second user who referred the second person are received. A determination is made that the person was previously referred by the particular one of the first plurality of users. Second referring member status information indicating whether or not the particular one of the first plurality of users is a paying member or a non-paying member is examined, and a second sum is paid to the particular one of the first plurality of users based on the second status information and the second referring member status information.

In another embodiment, a social network accessible via a network to a first plurality of registered users is maintained, wherein the first plurality of registered users comprises a second plurality of paying members and a third plurality of non-paying members.

In another embodiment, a sum is paid periodically to the particular one of the first plurality of users based on the status information and the referring member status information, while the person remains as registered user.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows components of a payment service in accordance with an embodiment;

FIG. 4 shows an exemplary personalized social networking page;

FIG. 5 is a flowchart of a method of compensating a user for referring a person to a social network in accordance with an embodiment;

FIG. 6A shows a payment chart in accordance with an embodiment;

FIG. 6B shows a payment chart in accordance with an embodiment;

FIG. 6C illustrates a system and method of compensating a member in accordance with an embodiment;

FIG. 6D illustrates a system and method for providing online tools to be used with respect to a contact and information relating to the contact in accordance with an embodiment;

FIG. 6E illustrates a charity post 2510 relating to a donation and a news feed 2520 displaying the donation in accordance with an embodiment;

FIG. 6F shows a system for utilizing member resources by a team in accordance with an embodiment;

FIG. 6G illustrates a system and method for determining a pay-out structure for a member in accordance with an embodiment; and

FIG. 7 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, a payment service 165, and a social network manager 145. Communication system 100 also comprises a plurality of user devices 160-A, 160-B, 160-C, etc.

For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. In one embodiment, user device 160 may include an Internet browser that enables a user to access content via the Internet. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Network manager 135 controls access to content and services. FIG. 2 shows components of network manager 135 in accordance with an embodiment. Network manager 135 includes a controller 210, a user registration & login module 220, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, in the illustrative embodiment of FIG. 2, a user registration database 265 containing usernames, passwords, and other information relating to various users is stored in storage 230. In one embodiment, user registration database 265 also stores information indicating whether each respective registered user is a paying member or a non-paying member. Network manager 135 may include other components not shown in FIG. 2.

In one embodiment, network manager 135 manages one or more websites that are accessible to registered users. Registered users may utilize the one or more websites to interact in a variety of ways, to play games, to purchase products and services, to search for desired information, etc. Consequently, network manager 135 manages a network of registered users. From time to time, network manager 135 may allow a person to register as a new user. In the illustrative embodiment, network manager 135 may define two or more classes of registered users. For example, network manager 135 may define a first class comprising paying members; paying members pay a periodic subscription fee and have access to a “premium” set of services. Network manager 135 may define a second class comprising non-paying members; non-paying members may have access to a more limited set of “basic” services. At the time of registration, a person may specify whether he or she wishes to register as a paying member or a non-paying member.

Social network manager 145 maintains a social networking website accessible via network 105 (subject to any access controls exercised by network manager 135). In a well-known manner, social network manager 145 supports a social network which enables users to interact in various ways. For example, social network manager 145 allows an individual to create and maintain a personalized social networking page containing personal information. For example, an individual's personalized social networking page may contain the individual's name, address, telephone number(s), email address, image, as well as information specifying the individual's hobbies, interests, and preferences. A personalized social networking page may also include other features such as a personalized blog with posts created by the individual, lists of the individual's friends, etc.

Payment service 165 manages a compensation system that compensates members for referrals—i.e., for bringing new people who register as members in the social network. In the illustrative embodiment, a current member may receive a sum of money for referring a person to the social network (if the person becomes a registered user); the member may receive a single payment, or periodic payments as long as the person remains a member. The amount of the payment(s) may depend on whether the referring member is a paying member or non-paying member, and may further depend on whether the person referred registers as a paying member or as a non-paying member. In some embodiments, a member who refers a person to the network may also receive additional compensation if the referred person refers a second person to the network (and the second person becomes a registered user), if the second person refers a third person, and so forth.

FIG. 3 shows components of payment service 165 in accordance with an embodiment. Payment service 165 comprises a payment manager 310 and a storage 325. Payment manager 310 applies one or more algorithms to determine payment amounts due to members. Payment service 165 may also make payments to members. Storage 325 may be used to store various types of data.

In one embodiment, payments are computed and made using a virtual currency managed by network manager 135. The virtual currency may be used on various websites managed by network manager 135 to purchase goods and services. In another embodiment, payments are computed and made using a selected real-world currency (e.g., United States Dollars).

As described above, social network manager 145 maintains a social network which allows users to create personalized social networking pages, and to interact in a variety of ways. FIG. 4 shows an exemplary social networking page that a user may maintain within the social network. Social networking page 400 comprises an image 410 of the user and identifying information 415 of the user (including name and address). Social networking page 400 also includes a list 420 of the user's online friends, and a personal blog 430. A social networking page may include other elements not shown in FIG. 4. In other embodiments, social network manager 145 may enable users to exchange messages of various types, to purchase goods and services via network 105, etc.

In one embodiment, network manager 135 may control access to services provided by other components of communication system 100. For example, network manager 135 may control access to the social network managed by social network manager 145.

In accordance with an embodiment, members of the social network are encouraged to contact friends, family, colleagues, acquaintances, etc., and refer other people to the social network managed by social network manager 145. If a member refers a person to the social network, and the person becomes a registered user, the referring member receives compensation. The compensation may comprise one or more sums of money.

FIG. 5 is a flowchart of a method of compensating a member for referring a person to a social network in accordance with an embodiment. At step 510, a website accessible to a first plurality of registered users, via a network, is maintained, wherein the first plurality of registered users comprises a second plurality of paying members and a third plurality of non-paying members. As described above, social network manager 145 maintains a social network that allows registered users to maintain personalized social networking pages and to access various services.

In an illustrative embodiment, suppose that a user of user device 160-A, named Bob, is a registered user of the social network managed by social networking manager 145. Suppose further that Bob calls a friend, named Mary, who employs user device 160-B, and convinces Mary to become a registered user of the social network. In order to register, Mary accesses an appropriate website maintained by social network manager 145, and enters her name and other identifying information. Mary also indicates that he or she was referred by Bob, and provides information identifying Bob. Mary also indicates whether she intends to be a paying member or a non-paying member. Social network manager 145 completes Mary's registration and transmits information identifying Mary and her member status to payment service 165. Social network manager 145 also transmits to payment service 165 information indicating that Mary was referred by Bob.

At step 520, registration information indicating that a person has registered, status information indicating whether the person has registered as a paying member or a non-paying member, and referring member identification information identifying a particular one of the first plurality of users as a member who referred the person, are received. Payment service 145 receives the information identifying Mary and her registration status, the information concerning her membership status (e.g., paying or non-paying), and the information identifying Bob as the referring member.

At step 530, referring member status information indicating whether the particular one of the first plurality of users is a paying member or a non-paying member is examined. Payment service 165 requests from network manager 135 information indicating whether Bob is a paying member or a non-paying member. Network manager 135 retrieves from user registration database 265 information indicating whether Bob is a paying member or a non-paying member, and provides the information to payment service 165.

At step 540, a sum is paid to the particular one of the first plurality of users based on the status information and the referring member status information. Payment service 165 uses an algorithm to determine a sum due to Bob, based at least in part on whether Mary is a paying member or non-paying member and whether Bob is a paying or non-paying member. The sum is paid to Bob. Payment may be effected in any suitable manner. Known methods of payment may be used.

Thus, in one embodiment the sum is a first amount if Bob is a paying member and Mary has registered as a paying member, a second amount if Bob is a paying member and Mary has registered as a non-paying member, a third amount if Bob is a non-paying member and Mary has registered as a paying member, and a fourth amount if Bob is a non-paying member and Mary has registered as a non-paying member.

In one embodiment, Bob receives a single payment for the referral. In other embodiments, Bob may receive periodic (e.g., monthly) payments as long as Mary remains a registered user. Such a payment (made to a member based on registration of another person whom the member referred) is referred to herein as a “first level payment.”

In accordance with another embodiment, payment service 165 may make an additional payment (or payments) to Bob if Mary (who was referred by Bob) refers a second person to the social network. Such a payment is referred to herein as a “second level payment.”

In another embodiment, payment service 165 may make an additional payment (or payments) to Bob if the second person (referred by Mary) refers a third person to the social network. Such a payment is referred to herein as a “third level payment.”

In another embodiment, payment service 165 may make an additional payment (or payments) to Bob if the third person (referred by the second person) refers a fourth person to the social network. Such a payment is referred to herein as a “fourth level payment.”

In various embodiments, fifth level payments, sixth level payments, seventh level payments, eighth level payments, ninth level payments, and further levels of payments, may be computed and paid to a user in a manner similar to that described above.

In one embodiment, a second level payment are a fraction of a first level payment, a third level payment is a fraction of a second level payment, a fourth level payment is a fraction of a third level payment, etc.

FIG. 6A shows a payment chart indicating various levels of payments due to a paying member in connection with a referral, in accordance with an embodiment. Payment chart 600 comprises three columns 601, 603, 605. Column 601 indicates various levels of payments, including a 1^{st} level, a 2^{nd} level, a 3^{rd} level, . . . , a 9^{th} level, etc. Payments are expressed in Units, which may be any suitable currency (virtual currency or real-world currency). Column 603 indicates a payment due to a paying member if the new member registers as a paying member. Column 605 indicates a payment due to a paying member if the new member registers as a non-paying member. Thus, records 621-629 indicate, respectively, that a first-level payment due to a paying member is 1 Unit (when the new member registers as a paying member) and 0.25 Units (when the new member registers as a non-paying member), a second-level payment due to a paying member is 0.25 Units (when the new member registers as a paying member) and 0.0625 Units (when the new member registers as a non-paying member), a third-level payment due to a paying member is 0.0625 Units (when the new member registers as a paying member) and 0.015 Units (when the new member registers as a non-paying member), a fourth-level payment due to a paying member is 0.015 Units (when the new member registers as a paying member) and 0.0039 Units (when the new member registers as a non-paying member), a fifth-level payment due to a paying member is 0.0039 Units (when the new member registers as a paying member) and 0.00098 Units (when the new member registers as a non-paying member), a sixth-level payment due to a paying member is 0.00098 Units (when the new member registers as a paying member) and 0.00024 Units (when the new member registers as a non-paying member), a seventh-level payment due to a paying member is 0.00024 Units (when the new member registers as a paying member) and 0.000061 Units (when the new member registers as a non-paying member), an eighth-level payment due to a paying member is 0.000061 Units (when the new member registers as a paying member) and 0.000015 Units (when the new member registers as a non-paying member), a ninth-level payment due to a paying member is 0.000015 Units (when the new member registers as a paying member) and 0.0000038 Units (when the new member registers as a non-paying member), etc. Additional levels may be implemented.

As described above, a member may receive a single payment or periodic payments in connection with a referral. Any other level of payment may likewise comprise a single payment or periodic payments.

In the illustrative embodiment, payments due to a non-paying member are determined differently. For example, a payment due to a non-paying member may be determined by computing a predetermined fraction of the corresponding amount given in chart 600. For example, in one embodiment, a payment due to a non-paying member may be determined by multiplying the corresponding amount given in chart 600 by one-fourth (0.25).

FIG. 6B shows a payment chart indicating various levels of payments due to a non-paying member in connection with a referral, in accordance with an embodiment. Payment chart 650 comprises three columns 651, 653, 655. Column 651 indicates various levels of payments, including a 1^{st} level, a 2^{nd} level, a 3^{rd} level, . . . , a 9^{th} level, etc. Payments are expressed in Units, which may be any suitable currency. Column 653 indicates a payment due to a non-paying member if the new member registers as a paying member. Column 605 indicates a payment due to a non-paying member if the new member registers as a non-paying member. Thus, records 621-629 indicate, respectively, that a first-level payment due to a non-paying member is 0.25 Units (when the new member registers as a paying member) and 0.625 Units (when the new member registers as a non-paying member), a second-level payment due to a non-paying member is 0.0625 Units (when the new member registers as a paying member) and 0.015 Units (when the new member registers as a non-paying member), a third-level payment due to a non-paying member is 0.015 Units (when the new member registers as a paying member) and 0.0039 Units (when the new member registers as a non-paying member), a fourth-level payment due to a non-paying member is 0.0039 Units (when the new member registers as a paying member) and 0.00098 Units (when the new member registers as a non-paying member), a fifth-level payment due to a non-paying member is 0.00098 Units (when the new member registers as a paying member) and 0.00024 Units (when the new member registers as a non-paying member), a sixth-level payment due to a non-paying member is 0.00024 Units (when the new member registers as a paying member) and 0.000061 Units (when the new member registers as a non-paying member), a seventh-level payment due to a non-paying member is 0.000061 Units (when the new member registers as a paying member) and 0.000015 Units (when the new member registers as a non-paying member), an eighth-level payment due to a non-paying member is 0.000015 Units (when the new member registers as a paying member) and 0.0000038 Units (when the new member registers as a non-paying member), a ninth-level payment due to a non-paying member (when the new member registers as a paying member) is 0.0000038 Units and 0.00000095 Units (when the new member registers as a non-paying member), etc. Additional levels may be implemented.

FIGS. 6A-6B are illustrative only. Other amounts may be used, and other formulae may be used to compute payment amounts.

In another embodiment, members can work together in teams to share resources and be compensated for the efforts of other people within their team.

In another embodiment, a member may cover their costs of a premium (paid) membership by referring in a predetermined number (for example, three) other premium (paid) members. FIG. 6C illustrates a system and method of compensating a member in accordance with an embodiment. If a member refers three members 2010, 2020, 2030 into the network, the member's membership costs 2050 are covered.

In another embodiment, an online calculator can take into account several variables to help members see what kind of potential they have in earning within the network/system based on the numbers they enter into the input fields.

In another embodiment, online tools are available to members so they can see who they contacted, how they contacted them, notes on each contact, lead status (hot/warm/cold), follow up plans, resources (scripts, templates, audio/video recordings, and more), statistics on their performance, encouraging messages about how they can get to the next level, training material, tutorials, and more tools that help themselves and their team succeed within the network/system. FIG. 6D) illustrates a system and method for providing online tools 2110 to be used with respect to a contact 2120, and information 2130 relating to the contact.

In another embodiment, a member is given a second bonus account that may only be used for charitable means. With one click on a charity post within the social network the member can donate to that charity, additional clicks on that same button would donate even more. FIG. 6E illustrates a charity post 2510 relating to a donation and a news feed 2520 displaying the donation in accordance with an embodiment.

In another embodiment, a team may utilize member resources. FIG. 6F shows a team and member resources in accordance with an embodiment. Team 3110 may access and utilize a plurality of different types of member resources 3120.

In accordance with another embodiment illustrated in FIG. 6G, a system and method of determining a pay-out structure for a member who refers persons to the social network is provided. Specifically, a referral calculator 3210 is used to determine a pay-out structure (3250) for a member who refers others to the network. The pay-out structure is determined based on a plurality of parameters, including a number of personal premium referrals (3211), a number of personal free referrals (3212), an average number of referrals in a member's downline (3213), and a percentage of a member's downline that are premium members (3214).

In various embodiments, the method steps described herein, including the method steps described in FIG. 5, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 7. Computer 700 includes a processor 701 operatively coupled to a data storage device 702 and a memory 703. Processor 701 controls the overall operation of computer 700 by executing computer program instructions that define such operations. The computer program instructions may be stored in data storage device 702, or other computer readable medium, and loaded into memory 703 when execution of the computer program instructions is desired. Thus, the method steps of FIG. 5 can be defined by the computer program instructions stored in memory 703 and/or data storage device 702 and controlled by the processor 701 executing the computer program instructions. For example, the computer program instructions can be implemented as computer executable code programmed by one skilled in the art to perform an algorithm defined by the method steps of FIG. 5. Accordingly, by executing the computer program instructions, the processor 701 executes an algorithm defined by the method steps of FIG. 5. Computer 700 also includes one or more network interfaces 704 for communicating with other devices via a network. Computer 700 also includes one or more input/output devices 705 that enable user interaction with computer 700 (e.g., display, keyboard, mouse, speakers, buttons, etc.).

Processor 701 may include both general and special purpose microprocessors, and may be the sole processor or one of multiple processors of computer 700. Processor 701 may include one or more central processing units (CPUs), for example. Processor 701, data storage device 702, and/or memory 703 may include, be supplemented by, or incorporated in, one or more application-specific integrated circuits (ASICs) and/or one or more field programmable gate arrays (FPGAs).

Data storage device 702 and memory 703 each include a tangible non-transitory computer readable storage medium. Data storage device 702, and memory 703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 705 may include peripherals, such as a printer, scanner, display screen, etc. For example, input/output devices 705 may include a display device such as a cathode ray tube (CRT) or liquid crystal display (LCD) monitor for displaying information to the user, a keyboard, and a pointing device such as a mouse or a trackball by which the user can provide input to computer 700.

Any or all of the systems and apparatus discussed herein, including network manager 135, payment service 165, and user device 160, and components thereof, including controller 210, user registration & login module 220, storage 230, payment manager 310, and storage 325, may be implemented using a computer such as computer 700.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
maintaining, by a processor, a website accessible, via a network, to a first plurality of registered users, wherein the first plurality of registered users comprises a second plurality of paying members and a third plurality of non-paying members;
receiving registration information indicating that a person has registered, status information indicating whether the person has registered as a paying member or a non-paying member, and referring member identification information identifying a particular one of the first plurality of users as a member who referred the person;
examining referring member status information indicating whether the particular one of the first plurality of users is a paying member or a non-paying member; and
paying to the particular one of the first plurality of users a sum based on the status information and the referring member status information.

2. The method of claim 1, wherein the sum comprises:
a first amount if the particular one of the first plurality of users is a paying member and the person has registered as a paying member;
a second amount if the particular one of the first plurality of users is a paying member and the person has registered as a non-paying member;
a third amount if the particular one of the first plurality of users is a non-paying member and the person has registered as a paying member; and
a fourth amount if the particular one of the first plurality of users is a non-paying member and the person has registered as a non-paying member.

3. The method of claim 1, further comprising:
receiving second registration information indicating that a second person has registered, second status information indicating whether the second person has registered as a paying member or a non-paying member, and second referring member identification information identifying the person as a second member who referred the second person;
determining that the person was previously referred by the particular one of the first plurality of users;
examining second referring member status information indicating whether the particular one of the first plurality of users is a paying member or a non-paying member; and
paying to the particular one of the first plurality of users a second sum based on the second status information and the second referring member status information.

4. The method of claim 3, wherein the second sum comprises:
a first amount if the particular one of the first plurality of users is a paying member and the second person has registered as a paying member;
a second amount if the particular one of the first plurality of users is a paying member and the second person has registered as a non-paying member;
a third amount if the particular one of the first plurality of users is a non-paying member and the second person has registered as a paying member; and
a fourth amount if the particular one of the first plurality of users is a non-paying member and the second person has registered as a non-paying member.

5. The method of claim 1, further comprising:
maintaining, by a processor, a social network accessible, via a network, to a first plurality of registered users, wherein the first plurality of registered users comprises a second plurality of paying members and a third plurality of non-paying members.

6. The method of claim 1, further comprising:
paying periodically to the particular one of the first plurality of users a sum based on the status information and the referring member status information, while the person remains as registered user.

7. A system comprising:
a storage adapted to store registration information, status information, and identification information; and
a processor adapted to:
maintain a website accessible, via a network, to a first plurality of registered users, wherein the first plurality of registered users comprises a second plurality of paying members and a third plurality of non-paying members;
receive registration information indicating that a person has registered, status information indicating whether the person has registered as a paying member or a non-paying member, and referring member identification information identifying a particular one of the first plurality of users as a member who referred the person;
examine referring member status information indicating whether the particular one of the first plurality of users is a paying member or a non-paying member; and
pay to the particular one of the first plurality of users a sum based on the status information and the referring member status information.

8. The system of claim 7, wherein the sum comprises:
a first amount if the particular one of the first plurality of users is a paying member and the person has registered as a paying member;
a second amount if the particular one of the first plurality of users is a paying member and the person has registered as a non-paying member;
a third amount if the particular one of the first plurality of users is a non-paying member and the person has registered as a paying member; and
a fourth amount if the particular one of the first plurality of users is a non-paying member and the person has registered as a non-paying member.

9. The system of claim 7, wherein the processor is further adapted to:
receive second registration information indicating that a second person has registered, second status information indicating whether the second person has registered as a paying member or a non-paying member, and second referring member identification information identifying the person as a second member who referred the second person;
determine that the person was previously referred by the particular one of the first plurality of users;
examine second referring member status information indicating whether the particular one of the first plurality of users is a paying member or a non-paying member; and
pay to the particular one of the first plurality of users a second sum based on the second status information and the second referring member status information.

10. The system of claim 9, wherein the second sum comprises:
a first amount if the particular one of the first plurality of users is a paying member and the second person has registered as a paying member;
a second amount if the particular one of the first plurality of users is a paying member and the second person has registered as a non-paying member;
a third amount if the particular one of the first plurality of users is a non-paying member and the second person has registered as a paying member; and
a fourth amount if the particular one of the first plurality of users is a non-paying member and the second person has registered as a non-paying member.

11. The system of claim 7, wherein the processor is further adapted to:
maintain a social network accessible, via a network, to a first plurality of registered users, wherein the first plurality of registered users comprises a second plurality of paying members and a third plurality of non-paying members.

12. The system of claim 7, wherein the processor is further adapted to:
pay periodically to the particular one of the first plurality of users a sum based on the status information and the referring member status information, while the person remains as registered user.
